(19) United States
(12) Patent Application Publication
(10) Pub. No.: US 2014/0289269 A1
(43) Pub. Date: Sep. 25, 2014

(54) Method, Device and System for Data Searching

(71) Applicant: TENCENT TECHNOLOGY (SHENZHEN) COMPANY LIMITED, SHENZHEN (CN)

(72) Inventor: Haijun Yang, Shenzhen (CN)

(21) Appl. No.: 14/185,141

(22) Filed: Feb. 20, 2014

Related U.S. Application Data
(63) Continuation of application No. PCT/CN2013/088094, filed on Nov. 28, 2013.

(30) Foreign Application Priority Data
Mar. 22, 2013 (CN) 2013100949017

(51) Int. Cl. G06F 17/30

(52) U.S. Cl. CPC G06F 17/30424
USPC 707/769

(57) ABSTRACT

A method, device and system for data searching are described. The method includes: acquiring a searching string input by a user; acquiring an attribute type of a first character string in the searching string that at least includes the first character string and a second character string; performing a data searching according to the searching string, the first character string and the attribute type of the first character string. The final search result is a union of the search result of the initial searching string and the search result of the first character string including the attribute type, thereby realizing diversification of the search results acquired by the user.

### CLAIM OF PRIORITY

The present patent application is a U.S. continuation application under 35 U.S.C. §111(a) claiming priority under 35 U.S.C. §§120 and 365(c) to International Application No. PCT/CN2013/088094 filed on Nov. 28, 2013, which claims priority of Chinese patent application No. 201310094901.7, entitled “Method and device for data searching” and filed by applicant Tencent Technology (Shenzhen) Co., Ltd on Mar. 22, 2013, which is incorporated into the present application by reference in its entirety.

### TECHNICAL FIELD

The disclosure relates to the field of a data searching, and in particular to a method, device and system for data searching.

### BACKGROUND

With the development of the application of the Internet, more and more users search for data through networks. A data searching is generally completed by means of a search engine, such as a vertical search engine.

### SUMMARY

In view of the above, the embodiments of the disclosure provide a method, device and system for data searching.

In an embodiment of the disclosure, a method for data searching is provided, which includes:

acquiring a searching string input by a user;

acquiring an attribute type of a first character string in the searching string, according to a second character string in the searching string; the searching string may at least include the first character string and the second character string;

performing a data searching according to the searching string, the first character string and the attribute type of the first character string.

In an embodiment of the disclosure, a device for data searching is provided, which includes:

a searching string acquiring module configured to acquire a searching string input by a user;

an attribute type acquiring module configured to acquire an attribute type of a first character string in the searching string according to a second character string in the searching string; the searching string may at least include the first character string and the second character string;

a data searching module configured to perform a data searching according to the searching string, the first character string and the attribute type of the first character string.

In an embodiment of the disclosure, a method for data searching is provided, which includes:

acquiring a first character string and a second character string from a searching string;

acquiring an attribute type of the first character string according to the second character string; and

performing a data searching according to the searching string, and the first character string and the attribute type of the first character string.

In an embodiment of the disclosure, a system for data searching is provided, which includes a server configured to:

acquire a first character string and a second character string from a searching string;

acquire an attribute type of the first character string according to the second character string; and

perform a data searching according to the searching string, and the first character string and the attribute type of the first character string.

In an embodiment of the disclosure, a non-transitory computer-readable storage medium including a set of instructions that, when executed, cause at least one processor to implement the above methods of the disclosure.

According to the technical solutions of the disclosure, the data searching is performed according to the searching string, the first character string and the attribute type of the first character string after acquiring the attribute type of the character string in the searching string, the final search result is a union of the search result of the initial searching string and the search result of the first character string including the attribute type, which realizes diversification of the search results acquired by the user.

### BRIEF DESCRIPTION OF THE DRAWINGS

For illustrating the technical solutions of the embodiments of the disclosure more clearly, the drawings referred to in the embodiments are briefly described below. It should be understood that the drawings are only some embodiments of the disclosure, and those skilled in the art can obtain other drawings according to these drawings without exercising inventive skill.

FIG. 1a illustrates a flowchart of a method for data searching provided by an embodiment of the disclosure;

FIG. 1b illustrates a structure schematic of an implementation environment of embodiments of the disclosure;

FIG. 2 illustrates a flowchart of a method for data searching provided by an embodiment of the disclosure;

FIG. 3 illustrates a schematic of displaying data search results provided by an embodiment of the disclosure;

FIG. 4 illustrates a structure schematic of a device for data searching provided by an embodiment of the disclosure; and

FIG. 5 illustrates a structure schematic of a terminal provided by an embodiment of the disclosure.

### DETAILED DESCRIPTION

Generally, a process of a data searching includes the following steps: a searching string to be searched for is acquired, and data is collected from the Internet by means of a search engine by using specific computer programs; the data are organized and processed, and then the data relevant to the searching string are sent to the user.

When a user performs a data searching with regard to an industry or a professional field, the user needs to use a vertical search engine, such as “Baidu mp3” for music and “Youku video” for video. When a vertical search engine is used for the data searching, the type of the data to be searched for should be defined in advance, then the data relevant to the searching string input by the user is searched for according to the delimited type, and finally the relevant data is sent to the user. For example, when a video searching is performed on video websites, i.e., the type of the data is define as a video in the vertical search engine, the searching string input by the user are searched for only in the data of video type, and the types of the search results sent back are all videos.

The vertical search engine requires the user to define the types of data to be searched for in advance, so the range of data to be searched for is narrow and the type of the search result is single, that is, diversification of the search results cannot be possible.

Embodiments disclosed below further consider the cost of the search behavior and diversification of the search results. By performing a data searching according to a searching string, a first character string in the searching string and an attribute type of the first character string, a final search result is a union of the search result of the initial searching string and the search result of the first character string including the attribute type, thereby realizing diversification of the search results acquired by the user and reducing the cost of the data searching.

In the following, the technical solutions in embodiments of the disclosure will be described in conjunction with the accompanying drawings. It should be understood that the embodiments described are a part of embodiments of the disclosure rather than all of the embodiments of the disclosure. Base on the embodiments of the disclosure below, all the other embodiments obtained by those skilled in the art without exercising inventive skill belong to the scope of the disclosure.

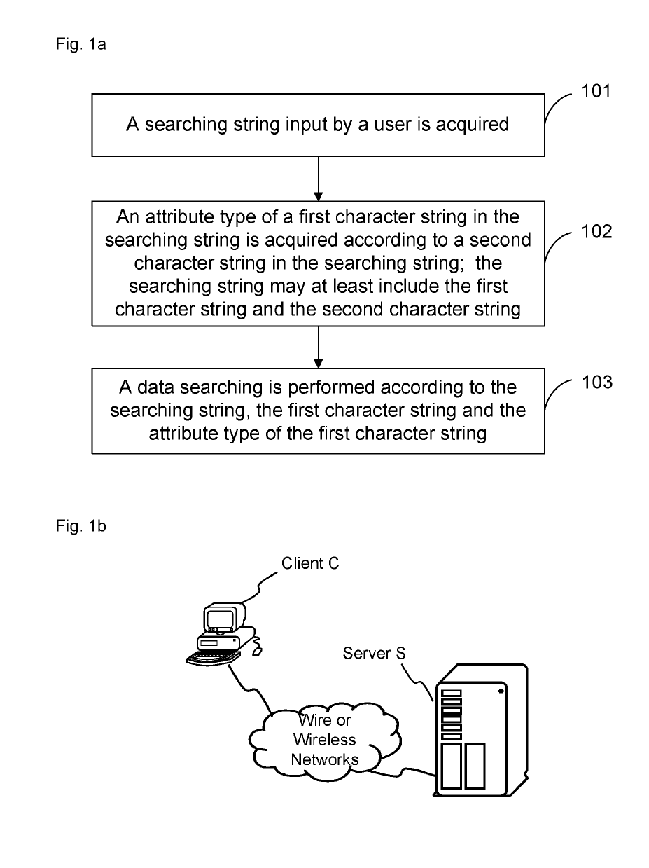

FIG. 1a illustrates a flowchart of a method for data searching provided by an embodiment of the disclosure. In this embodiment, the method is implemented by a server, such as a search engine server. As shown in FIG. 1a, the method for data searching may include the following steps:

At step 101, a searching string input by a user is acquired.

In the embodiment of the disclosure, when the user needs to perform a data searching, the user inputs a searching string to be searched for into a search bar provided by a terminal. The server acquires the searching string so as to perform the data searching in a database of the server according to the searching string. The searching string may at least include two character strings, such as a first character string and a second character string.

At step 102, an attribute type of the first character string in the searching string is acquired according to the second character string in the searching string.

The searching string can be divided into multiple character strings according to a word segmentation method. The multiple character strings at least include the first character string and the second character string, which are associated with each other. For example, for a searching string of “WangFei's songs”, the first character string is “WangFei”, and the second character string is “songs”.

In the embodiment of the disclosure, a mapping relationship between multiple preset key character strings and attribute types is established in advance and stored in a database of the server. By means of querying the mapping relationship, it can be determined whether the second character string in the searching string is a preset key character string. When the second character string is found in the mapping relationship, it is determined that the second character string is a preset key character string, therefore, the second character string has a corresponding attribute type. The attribute type of the second character string is taken as the attribute type of the first character string associated with the second character string. When the second character string is not found in the mapping relationship, it is determined that the second character string is not a preset key character string, that is, does not have a corresponding attribute type.

The mapping relationship may be set by technicians during the process of the technical development. Preset key character strings can be update timely in the course of using users, and the mapping relationship between the preset key character strings and the attribute types thereof is established, so as to meet the user requirement for the data searching much better.

At step 103, a data searching is performed according to the searching string, the first character string and the attribute type of the first character string.

Specifically, coding is performed respectively on the searching string and on the first character string and the attribute type of the first character string; when the coding is completed, a searching request is triggered. According to the coding results of the searching string, the first character string and the attribute type of the first character string, data searching is performed in the database respectively for the searching string, and for the first character string and the attribute type of the first character string. The search results include the search result corresponding to the searching string and the search result corresponding to the first character string and the attribute type of the first character string, that is, the search results are a union of the two parts of search results above.

It should be noted that, the above-mentioned searching process according to the searching string and the searching process according to the first character string and the attribute type of the first character string do not have any inevitable sequential relationship. When the searching request is received, the above-mentioned two searching processes can be performed either simultaneously or in sequence.

For example, when the searching string is “WangFei's songs”, the first character string is “WangFei” and the second character string is “songs”. Coding is performed respectively on the searching string “WangFei's songs”, and on the first character string “WangFei” and the attribute type “music”. After the coding is completed, the data searching is performed in the database according to the coding results. A first search result is acquired by searching for the searching string “WangFei's songs”. The first search result may include web page links with web page content including “WangFei's songs”. Meanwhile, the first character string “WangFei” is searched for, and the data that pertains to the attribute type “music” in the search results is acquired as a second search result. The second search result may include web page links of the data in the form of mp3, such as the web page link of WangFei (singer)-Hongdou (song name). MP3. The user may browse the text information including “WangFei's songs” by clicking any web page link in the first search result; the user may link to any song of WangFei to listen by clicking any web page link in the second search result.

When the searching string includes two or more first character strings and two or more second character strings, the first character strings and second character strings associated with each other can be determined according to a space between character strings or by means of other approaches, and the data searching is performed according to the two or more first character strings and the two or more second character strings that have been determined. For example, when the searching string is “ChengLong's movies and FangZuming' songs”, coding and data searching are performed on the searching string “ChengLong's movies and FangZuming' songs” to obtain web page links of relevant data. In addition, coding is performed on the character string “ChengLong” and attribute type “video”, and data searching is performed on the character string “ChengLong”, the web page links of the data pertaining to the attribute type “video” in the search result are acquired; Coding is performed on the character string “FangZuming” and the attribute type “music”, and data searching is performed on the character string “FangZuming”, the web page links of the data pertaining to the attribute type “music” in the search result are required. The search results are combined to obtain final search results of the searching string.

According to the method provided by the embodiment of the disclosure, the searching string input by the user is acquired; the attribute types of character strings in the searching string are acquired; the data searching is performed according to the searching string, the character strings and the attribute types of the character strings. Using the technical solutions of the disclosure, the attribute types of the character strings in the searching string are acquired, and then the data searching is performed according to the searching string, the first character string and the attribute type of the first character string. The final search results are a union of the search results of the initial searching string and the search results of the first character string including the attribute type, which realizes diversification of the search results acquired by the user.

Alternatively, based on the technical solution of the embodiment shown in the FIG. 1a, the step 102 “an attribute type of the first character string in the searching string is acquired according to the second character string in the searching string” includes steps 102a, 102b and 102c.

At step 102a, at least two character strings are acquired from the searching string;

Word segmentation is performed on the searching string according to existing word segmentation methods. The searching string is segmented into at least two character strings to acquire at least two character strings. Definitely, at least two character strings can also be acquired from the searching string by means of other semantic analysis method. The embodiment of the disclosure is not limited to the word segmentation methods.

In prior art, there are various kinds of word segmentation methods, including segmenting by analyzing semantic and segmenting by matching character strings stored in the database. For example, for the searching string “WangFei's songs”, “WangFei” is stored in the database, “WangFei” can thus be treated as one character string during the segmenting; since “Fei's” is not stored in the database, “Fei's” is not a character string. Thus the result of word segmenting of the searching string is that the first character string is “WangFei” and the second character string is “songs.”

At step 102b, the at least two character strings is detected to determine whether a preset key character string is included.

Preset key character strings are the character strings stored in the database and having corresponding attribute types, such as the character string “songs” stored in the database has the corresponding attribute type “music”, which means that the character string “songs” is a preset key character string.

When it is determined that the mapping relationship between the character strings and the attribute types in the database includes any one of the at least two character strings, it is determined that the any one character string is a preset key character string, that is, the any one character string has a corresponding attribute type. Conversely, If it is determined that the mapping relationship between the character strings in the database and the attribute types does not include any one of at least two character strings, it is determined that none of the at least two character strings are preset key character strings, that is, none of the at least two character strings have the corresponding attribute type.

It should be noted that, in the mapping relationship, one preset key character string corresponds to one attribute type, and one attribute type may correspond to several preset key character strings. For example, the attribute type corresponding to a preset key character string “songs” is “music”, while the preset key character strings corresponding to the attribute type “music” may include “melody”, “song”, and “album”, which is not limited in the embodiment of the disclosure.

A step 102c, when the second character string of the at least two character strings is a preset key character string, the attribute type corresponding to the preset key character string is taken as the attribute type of the first character string.

In the embodiment of the disclosure, the attribute types are used to limit the data type of the data searching. The attribute type may be “music”, “video” and “ppt”.

Specifically, when the second character string of the at least character strings is a preset key character string, the attribute type corresponding to the preset key character string is acquired by querying the mapping relationship, and the attribute type is taken as the attribute type of the first character string. The first character string is the character string associated with the second character string in the at least two character strings.

For example, when the searching string is “ChengLong's movies”, querying the mapping relationship between character strings and attribute types in the database, according to the first character string “ChengLong” and the second character string “movies”, which are the results of segmenting. When the character string “ChengLong” is not found, the character string “ChengLong” does not have the corresponding attribute type. When the character string “movies” is found, the second character string “movies” is a preset key character string and the character string “movies” has a corresponding attribute type and the attribute type is “video”, the attribute type “video” corresponding to the character string “movies” is taken as the attribute type of the first character string “ChengLong”.

When the searching string includes two or more first character strings and two or more second character strings, the first character string and second character string associated with each other can be determined according to the space between the character strings or by means of other approaches. For example, when the searching string is “ChengLong's movies and FangZuming' songs”, according to the space between the character strings and the semantic, the character string “ChengLong” is associated with the character string “movies” and the character string “FangZuming” is associated with the character string “songs”, so the attribute type “videos” corresponding to the character string “movies” is taken as the attribute type of character string “ChengLong”, and the attribute type “music” corresponding to the character string “songs” is taken as the attribute type of character string “FangZuming”.

Alternatively, based on the technical solution of the embodiment shown in FIG. 1a, step 103 “the data searching is performed according to the searching string, the first character string and the attribute type of the first character string” includes step 103a.

At step 103a, the data searching is performed in the database according to the searching string, the first character string and the attribute type of the first character string respectively, web page links in the database that match the searching string or match the first character string and the attribute type thereof are taken as the first search result.

When the data of any web page link includes the searching string, it is determined that the any web page link matches the searching string; when the data of any web page link includes the first character string and the attribute type of the data matches the attribute type of the first character string, it is determined that the any web page link matches the first character string and the attribute type of the first character string.

Specifically, it is detected whether any web page link in the database matches the searching string, and whether any web page link matches the first character string and the attribute type of the first character string. When the any web page link matches the searching string or matches the first character string and the attribute type of the first character string, the any web page link is taken as the first search result. Every web page link in the database is detected such that the first search result includes all the web page links in the database that match the searching string or match the first character string and the attribute type of the first character string. The first search result is displayed to the users after the detecting such that the users can browse the web page corresponding to the web page links or open the music or videos of the corresponding attribute type.

At the step 103a, each web page link in the database is detected respectively to determine whether the web page link matches with the searching string, meanwhile, whether the web page link matches with the first character string and the attribute type of the first character string. After detecting every web page link, the first search result including two parts of results is acquired at the same time, which saves the overhead of a system.

In the embodiment of the disclosure, according to the attribute type, the data that does not pertain to the attribute type in the first character string can be filtered out such that the user do not have to browse all the related contents of the first character string, but only browses the data of the attribute type that the user is interested in.

Alternatively, based on the technical solution of the embodiment shown in FIG. 1a, step 103 “the data searching is performed according to the searching string, the first character string and the attribute type of the first character string” further includes steps 103b, 103c, 103d and 103e.

At step 103b, a data searching is performed according to the searching string to acquire a second search result including web page links matching the searching string.

Specifically, all the web page links in the database are detected to determine whether those web page links match the searching string; the web page links matching the searching string are taken as the second search result, that is, the second search result includes all the web page links in the database that match the searching string.

At step 103c, a data searching is performed according to the first character string to acquire a third search result including web page links matching the first character string.

Specifically, all the web page links in the database are detected to determine whether those web page links match the first character string, the web page links matching the first character string are taken as the third search result, that is, the third search result includes all the web page links in the database that match the first character string.

At step 103d, filtering is performed on the third search result according to the attribute type of the first character string, and a fourth search result is acquired.

The web page links in the third search result that do not pertain to the attribute type of the first character string are filtered out, such that the fourth search result includes only the web page links matching the attribute type of the first character string.

The steps 103c and 103d can be replaced with the following steps: any web page link in the database is detected to determine whether the web page link matches with the first character string; when the any web page link matches with the first character string, it is determined whether the data of the any web page link pertains to the attribute type of the first character string, i.e., whether the any web page link matches with the attribute type of the first character string. When the any web page link matches with the attribute type of the first character string, the any web page link is taken as the fourth search result. By detecting every web page link in the database in such a way, the fourth search result includes all the web page links matching the first character string and the attribute type of the first character string.

At step 103e, the second search result and the fourth search result are combined.

Different from the step 103a, at the steps 103b, 103c, 103d and 103e, the second search result is acquired by detecting whether each web page link in the database matches with the searching string, and the fourth search result is acquired by detecting whether each web page link in the database matches with the first character string and the attribute type of the first character string, thereby improving the accuracy of the data searching. The user could choose to perform any one of above-mentioned two searching process, which avoids the waste of the system and reduce the search time.

In an embodiment, based on the technical solutions of the embodiment shown in FIG. 1 a, the first character string may include attributes of the second character string.

In the embodiment of the disclosure, when the second character string has a corresponding attribute type, the attribute of the second character string is taken as the first character string and the attribute type corresponding to the second character string is taken as the attribute type of the first character string. The first character string is associated with the second character string and limits or modifies the second character string.

Taking the attribute type corresponding to the second character string as the attribute type of the first character string is to associate the first character string with the attribute type; accordingly, during the data searching, the first character string serving the function of limiting the second character string can be taken as a search key word, meanwhile, the search results of the first character string can be filtered according to the attribute type to acquire the search results corresponding to the first character string and the attribute type of the first character string. Therefore, it is avoided that all of the search results of the first character string or all of the search results of the second character string are acquired due to using the first character string or second character string as the search key word, thus satisfying the search requirements of the users much better.

Any combination of all the technical solutions mentioned above can form an optional embodiment of the disclosure, which is not detailed herewith.

According to the method provided by the embodiment of the disclosure, the searching string input by the user is acquired; the attribute types of character strings in the searching string are acquired; the data searching is performed according to the searching string, the character strings and the attribute types of the character strings. Using the technical solutions of the disclosure, the attribute types of the character strings in the searching string are acquired, and then the data searching is performed according to the searching string, the first character string and the attribute type of the first character string. The final search result are a union of the search result of the initial searching string and the search result of the first character string including the attribute type, which realizes diversification of the search results acquired by the user.

FIG. 1b illustrates the structure schematic of an implementation environment of embodiments of the disclosure. As shown in FIG. 1b, the implementation environment includes a client C and a server S.

The client C is connected with the server S through wired networks or wireless networks. The client C may be an electronic device capable of accessing the websites having searching function. The electronic device may be a computer, a smart phone, a tablet computer or other electronic devices. Any user can access the websites having searching function by means of the client C.

The server S may be a search engine server provided by any operator, which includes a database, in which the data searching is performed.

The server S may be a cluster of search engine servers.

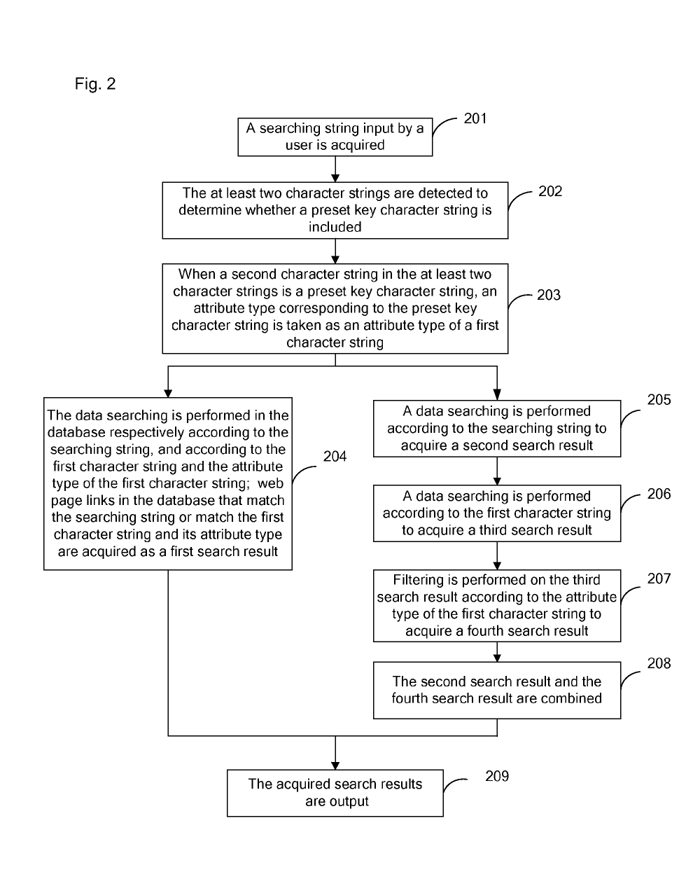

FIG. 2 illustrates a flowchart of a method for data searching provided by an embodiment of the disclosure. The embodiment of the disclosure is applied in the scenario of the web page of microblog or the client. As shown in FIG. 2, the method includes the following steps:

At step 201, a searching string input by a user is acquired.

When a user needs to perform a data searching, the user inputs the searching string to be searched for into the searching bar provided by the web page of the microblog or the client, and triggers the searching process for the searching string by clicking the corresponding buttons.

Different from the vertical search engines, it is not necessary to define the classification of the searching string in advance according to the embodiment of the disclosure, but just to input the searching string by the users. In the subsequent process of the data searching, the searching is performed according to the character strings included in the searching string and the attribute types of the character strings, to acquire search results pertaining to the attribute types, which are then provided to the users for browsing.

The searching string may include at least two character strings, such as a first character string and a second character string.

At step 202, the at least two character strings are detected to determine whether a preset key character string is included;

In the embodiment of the disclosure, a database of the server has stored a mapping relationship between multiple preset key character strings and attribute types.

At step 203, when a second character string in the at least two character strings is a preset key character string, an attribute type corresponding to the preset key character string is taken as an attribute type of a first character string, and then performing step 204 or step 205.

When the second character string is the preset key character string, the attribute type corresponding to the preset key character string is acquired according to the mapping relationship between the character strings and attribute types, and the attribute type is taken as the attribute type of the first character string which corresponds to the second character string.

At step 204, the data searching is performed in the database respectively according to the searching string, and according to the first character string and the attribute type of the first character string; web page links in the database that match the searching string or match the first character string and its attribute type are acquired as a first search result, then performing step 209;

In the embodiment of the disclosure, the first search result includes two parts of results, which are the web page links matching the searching string and the web page links matching the first character string and the attribute type of the first character string. The two parts of results can be displayed separately, which is available for the users to choose by clicking the corresponding buttons, and also can be displayed according to the establishment time of the web page links; It is not limited in the embodiment of the disclosure.

At step 205, a data searching is performed according to the searching string to acquire a second search result.

At step 206, a data searching is performed according to the first character string to acquire a third search result.

There is no inevitable sequential relationship between step 205 and step 206. In the embodiment of the disclosure, for example, the step 205 is performed before the step 206.

At step 207, filtering is performed on the third search result according to the attribute type of the first character string to acquire a fourth search result;

In the step 207, the web page links in the third search result that do not pertain to the attribute type of the first character string are filtered out, to acquire a fourth search result that only includes the web page links matching the attribute type of the first character string.

Still taking the searching string “WangFei's songs” for example, the data searching is performed according to the first character string “WangFei” to acquire a third search result; the web page links in the third search result that do not pertain to the attribute type “music” are filtered out, such as filtering out the web page links “WangFei Baidupedia”, “WangFei's microblog”, “WangFei's latest news”, etc., to acquire a fourth search result that includes the web page links of data that pertains to the attribute type “music” such as “Hongdou-WangFei”, “Because of love-WangFei”, etc.

At step 208, the second search result and the fourth search result are combined, and then performing step 209.

The steps 205 to 208 are illustrated as examples of performing data searching according to the searching string, and the first character string and the attribute type of the first character string, and then combining the acquired search results.

At step 209, the acquired search results are output.

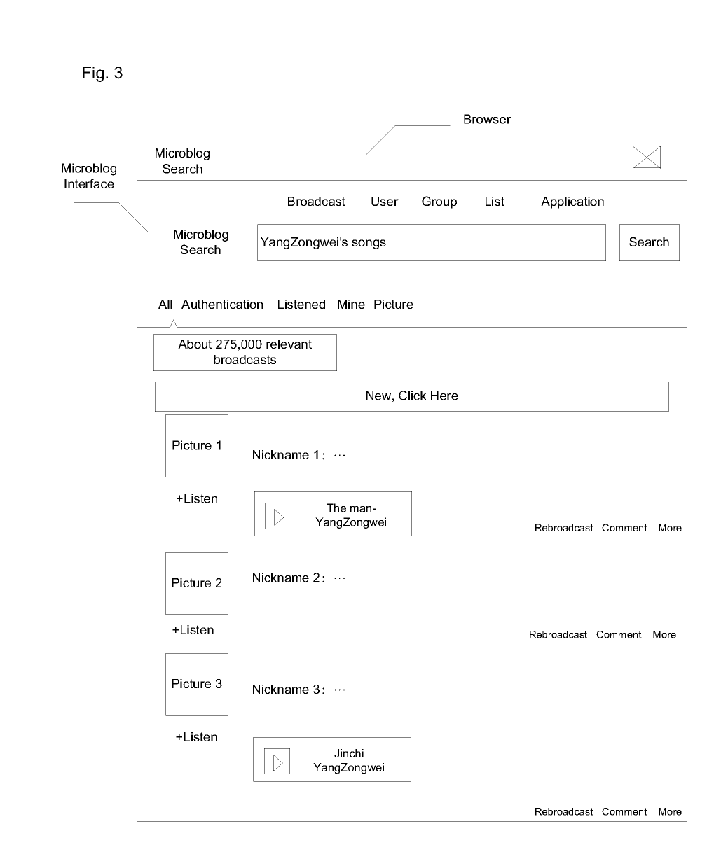

In order to further illustrate the detailed description of the embodiment of the disclosure, FIG. 3 is referred to. FIG. 3 illustrates a schematic of display the data search results provided by an embodiment of the disclosure. The search results are stored in the form of web page links in the database. When the search results are displayed on a search output interface, a part of text information of any web page link and the website corresponding to the web page link can be displayed. A web page corresponding to the web page link is jumped to after the website is clicked. The part of text information generally selects the text information including the searching string; the color of the searching string can be different from other text information for the purpose of highlighting and prompting the users.

When the web page links matching the first character string and the attribute type of the first character string are displayed on the current interface, the links of data pertaining to the attribute type can be provided. Based on the example in FIG. 3, when the searching string is “YangZongwei's songs”, the search results include not only the relevant text information about “YangZongwei's songs”, e.g. the information issued by a user “nickname 2”, but also the links of “The man-YangZongwei” and “Jinchi YangZongwei”. A user can listen to the song of YangZongwei, “The man” or “jinchi”, by clicking the corresponding links.

According to the method provided by the embodiment of the disclosure, the searching string input by the user is acquired; the attribute types of character strings in the searching string are acquired; the data searching is performed according to the searching string, the character strings and the attribute types of the character strings. Using the technical solutions of the disclosure, the attribute types of the character strings of the searching string are acquired, and then the data searching is performed according to the searching string, the first character string and the attribute type of the first character string. The final search results are a union of the search result of the initial searching string and the search result of the first character string including the attribute type, which realizes diversification of the search results acquired by the user, meanwhile filters out the data of other attribute types.

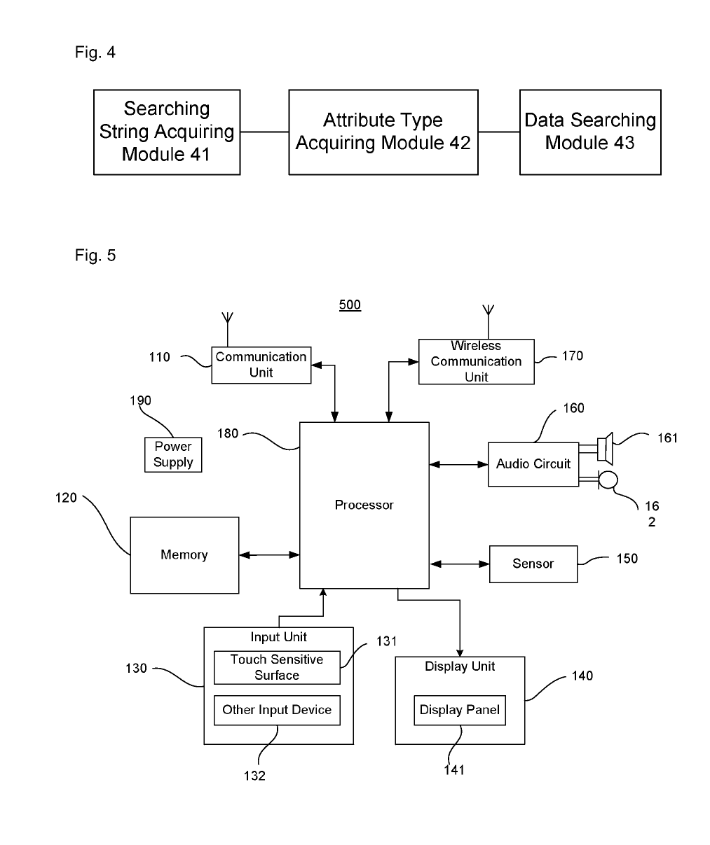

FIG. 4 illustrates a structure schematic of a device for data searching. As shown in FIG. 4, the device includes a searching string acquiring module 41, an attribute type acquiring module 42 and a data searching module 43.

The searching string acquiring module 41 is configured to acquire a searching string input by a user.

The attribute type acquiring module 42 is configured to acquire an attribute type of the first character string according to a second character string in the searching string that at least includes the first character string and the second character string.

The data searching module 43 is configured to perform the data searching according to the searching string, the first character string and the attribute type of the first character string.

Alternatively, the attribute type acquiring module 42 includes a segmenting unit, a preset detecting unit and an attribute type acquiring unit.

The segmenting unit is configured to acquire at least two character strings from the searching string.

The preset detecting unit is configured to detect whether the at least two character strings include a preset key character string.

The attribute types acquiring unit is configured to take the attribute type corresponding to the preset key character string as the attribute type of the first character string when the second character string in the at least two character strings is a preset key character string.

Alternatively, the data searching module 43 includes a first searching unit.

The first searching unit is configured to perform the data searching respectively according to the searching string, and according to the first character string and the attribute type of the first character string in the database, and to acquire web page links in the database that match the searching string or match the first character string and its attribute type as the first search result.

Alternatively, the data searching module 43 further includes a second searching unit, a third searching unit, a filtering unit and a combining unit.

The second searching unit is configured to perform a data searching according to the searching string to acquire a second search result that includes web page links matching the searching string.

The third searching unit is configured to perform a data searching according to the first character string to acquire a third search result that includes the web page links matching the first character string.

The filtering unit is configured to filter the third search result according to the attribute type of the first character string to acquire a fourth search result.

The combining unit is configured to combine the second search result with the fourth search result.

In an embodiment of the disclosure, the first character string may include the attributes of the second character string.

It should be noted that, when the data searching is performed, the device for data searching provided by the above-mentioned embodiments of the disclosure is only illustrated according to the partition of the above-mentioned functional modules. In practical application, the functions can be allocated and accomplished by different functional modules as required, that is to say, the inner structure of the device is partitioned into different functional modules so as to accomplish all or part of the above-mentioned functions. Further, the device for data searching provided by the above-mentioned embodiments and the method embodiments for the data searching pertain to the same concept, therefore, the implementation process of the device embodiments can be referred to the method embodiments without no more details given here.

FIG. 5 illustrates a structure schematic of a terminal provided by an embodiment of the disclosure. As shown in FIG. 5, the terminal may be used to implement the data searching method provided by the aforementioned embodiments. When a user needs to perform a data searching, the user inputs a searching string to be searched for into a search bar provided by the terminal.

The terminal 500 may include a communication unit 110, a memory 120 including one or more computer readable storage mediums, an input unit 130, a display unit 140, a sensor 150, an audio circuit 160, a wireless communication unit 170, a processor 180 including one or more processing cores, a power supply 190, etc. Those skilled in the art should understand that the structure of the terminal shown in FIG. 5 does not constitute a limitation to the terminal. The terminal can include more or less components than those shown in the FIG. 5, or include a combination of some components, or have a different arrangement of the components.

The communication unit 110 is configured to send and receive messages, and to receive and send signals during a communication process. The communication unit 110 may be a network communication device such as a Radio Frequency (RF) circuit, a Router, a modem, etc. Specifically, when the communication unit 110 is an RF circuit, the communication unit 110 transmits a downlink message received from a base station to one or more processors 180 to be processed, and transmits uplink data to the base station. Typically, as a communication unit, the RF circuit includes but does not limit to an antenna, at least one amplifier, a tuner, one or more oscillators, a Subscriber Identify Module (SIM) card, a transceiver, a coupler, a Low Noise Amplifier (LNA),and a duplexer. In addition, the communication unit 110 can communicate with other devices by wireless communication or a network. The wireless communication can use any communication standard or protocol, which includes but does not limit to a Global System of Mobile communication (GSM), a General Packet Radio Service (GPRS), a Code Division Multiple Access (CDMA), a Wideband Code Division Multiple Access (WCDMA), a Long Term Evolution (LTE), emails, a Short Messaging Service (SMS). The memory 120 is configured to store software programs and modules. The processor 180 performs various functional applications and data-processing by running the software programs and modules stored in the memory 120. The memory 120 may mainly include a storing program area and a storing data area; the storing program area can store an operating system, at least one application program required by functions (such as voice broadcast function, image playing function, etc.), and so on; the storing data area can store the data (such as audio data, telephone books, etc.) established according to the usage of the terminal 500. Furthermore, the memory 120 may include a high speed random access memory, and also may include a nonvolatile memory, such as, at least one disk storage device, a flash memory or other volatile solid-state storage devices. Accordingly, the memory 120 may also include a memory controller, so as to provide an access to the memory 120 by the processor 180 and the input unit 130.

The input unit 130 may be configured to receive the input numerals or character information, and to produce an input of signals from a keyboard, a mouse, a lever, trackball or optical signals in relation to the settings by users and function control. Specifically, the input unit 130 may include a touch sensitive surface 131 and other input device 132. The touch sensitive surface 131 also called touch screen or touchpad can collect the touch operations of the users (for example, the operations on the touch sensitive surface 131 or near the touch sensitive surface 131 using fingers, touch pen or any suitable object or accessory by users) thereon or nearby, and drive the corresponding connecting devices according to the preset programs. Alternatively, the touch sensitive surface 131 may include two parts, a touch detection device and a touch controller; the touch detection device detects the touching orientation of users, and detects a signal generated due to the touch operations, and transmits the signal to the touch controller. The touch controller receives the touch information from the touch detection device and converts it into contact coordinates, then transmits them to the processor 180 and receives the instructions sent by the processor 180 and performs processing. In addition, the touch sensitive surface 131 can be realized in various types such as the resistive, the capacitive, infrared ray, and surface acoustic wave. The input unit 130 may include other input device 132 except for the touch sensitive surface 131. Specifically, the other input device 132 may include but not limit to one or more of the following element: a physical keyboard, functional keys (such as the volume control buttons, on/off keys, etc.), trackballs, a mouse, and a lever.

The display unit 140 may be configured to display the information input by the users or provided to the users and various graphical user interfaces of the terminal 500. These graphical user interfaces can consist of graphic, text, icons, videos and any combination thereof. The display unit 140 may include display panel 141. Alternatively, the display panel 141 may be configured in the form of Liquid Crystal Display (LCD), Organic Light-Emitting Diode (OLED), etc. Further, the touch sensitive surface 131 can cover the display panel 141. When the touch sensitive surface 131 detects a touch operation performed thereon or nearby, the touch operation is transmitted to the processor 180 to determine the type of the touch event, afterwards, the processor 180 provides the corresponding visual output on the display panel 141 according to the type of the touch event. In FIG. 5, although the touch sensitive surface 131 and the display panel 141 are two separate components to implement the function of inputting and outputting, however, in some embodiments, the touch sensitive surface 131 and the display panel 141 can be integrated to implement the function of inputting and outputting.

The terminal 500 may further include at least one kind of sensor 150 such as an optical sensor, a motion sensor and other sensors. Specifically, the optical sensor may include an ambient light sensor and a proximity sensor; the ambient light sensor can adjust the brightness of the display panel 141 according to the brightness of the ambient light; the proximity sensor can turn off the display panel 141 and/or backlight when the terminal 500 is moved near ear. As one kind of motion sensor, a gravity acceleration sensor can detect the value of acceleration in all the direction (3-axis typically), the value and direction of gravity at rest, be used for the application of identifying the mobile attitude (such as the switch between the landscape and portrait, relevant games, calibration of magnetometers attitude), the relevant function of vibration recognition (such as pedometer, tapping), etc. As for the gyroscope, barometer, hygrometer, thermometer, infra-red sensor which can be configured in the terminal 500, their details are not given here.

An audio circuit 160, a loudspeaker 161, a microphone 162 can provide an audio interface between the user and the terminal 500. The audio circuit 160 can convert the received audio data into an electrical signal, which is transmitted then to the loudspeaker 161, the loudspeaker 161 converts the electrical signal into a sound signal and outputs the sound signal. On the other hand, the microphone 162 converts the collected sound signal into electrical signal that is received and converted into audio data by the audio circuit 160. After the audio data is output to the processor 180 to be processed, the audio data is sent to, for example, another terminal via the RF circuit 110, or alternatively, the audio data is output to the memory 120 to be further processed. The audio circuit 160 may also include an earplug jack so as to provide the communication between a peripheral headphone and the terminal 500.

In order to realize the wireless communication, the terminal can be configured with a wireless communication unit 170. The wireless communication unit 170 may be a WiFi module. WiFi belongs to short distance wireless transmission technology. By means of the wireless communication unit 170, the terminal 500 can help the users receive and send e-mails, browse the web and access streaming medium, etc. It provides the users with wireless broadband internet access. Although the wireless communication unit 170 is shown in FIG. 5, it should be understood that the wireless communication unit 170 does not belong to the indispensable constitution of the terminal 500 and can be omitted absolutely within the scope of not altering the nature of the disclosure as required.

The processor 180 is a control center of the terminal 500 and connects each part of mobile phone with various interfaces and circuits, and performs the various functions of the terminal 500 and processes the data by running or carrying out the soft programs and/or modules stored in the memory 120 and invoking the data stored in the memory 120, so as to monitor the whole mobile phone. Alternatively, the processor 180 may include one or more processing cores. For example, the processor 180 can integrate an application processor and a modem processor; the application processor mainly processes the operation system, the user interfaces, the application programs, etc., while the modem processor mainly processes wireless communication. It should be understood that the modem processor above may be not integrated into the processor 180.

The terminal 500 further includes a power supply (such as a battery) 190 that powers each component. For example, the power supply 190 can be connected with the processor 180 logically by a power management system so as to implement the function of managing the charging, discharging and the power consumption, etc. The power supply 190 may further include any component such as one or more direct current supplies or alternating current supplies, a recharging system, a power failure detecting circuit, a power converter or inverter, a power status indicator, etc.

Despite not shown, the terminal 500 can further include a camera, a bluetooth module, etc., and the details are not given here. Specifically in the embodiment, the display unit of the terminal is a touch-screen display. The terminal further includes a memory, and one or more programs that are stored in the memory. The one or more programs include the instructions, when executed by one or more the processors, performing the following operations:

acquiring a searching string input by a user;

acquiring an attribute type of a first character string in the searching string according to a second character string in the searching string; the searching string at least includes the first character string and the second character string;

performing a data searching according to the searching string, the first character string and the attribute type of the first character string.

Assuming that the above is the first possible embodiment, then in the second embodiment provided on the basis of the first possible embodiment, the memory in the terminal may further include instructions for performing the following operations:

acquiring at least two character strings from the searching string;

detecting whether the at least two character strings include a preset key character string;

when the second character string in the at least two character strings is a preset key character string, taking the attribute type corresponding to the preset key character string as the attribute type of the first character string.

In the third possible embodiment provided on the basis of the first possible embodiment, the memory in the terminal may further include the instructions for performing the following operations:

performing the data searching in the database respectively according to the searching string, and according to the first character string and the attribute type of the first character string, acquiring web page links in the database that match the searching string or match the first character string and the attribute type of the first character string as the first search result.

In the third possible embodiment provided on the basis of the first possible embodiment, the memory in the terminal may further include the instructions for performing the following operations:

performing the data searching according to the searching string to acquire a second search result that includes the web page links matching the searching string;

performing the data searching according to the first character string to acquire a third search result that includes the web page links matching the first character string;

filtering the third search result according to the attribute type of the first character string to acquire a fourth search result;

combining the second search result with the fourth search result.

In the fourth possible embodiment provided on the basis of any possible above-mentioned embodiment, the memory in the terminal may further include the instructions for performing the following operations:

The first character string includes attributes of the second character string.

In another aspect, another embodiment of the disclosure further provides a non-transitory computer-readable storage medium. The non-transitory computer-readable storage medium may be the computer-readable storage medium that are included in the memory in the above-mentioned embodiments, or a computer-readable storage medium that exists independently, i.e., that are not installed into the terminal. The non-transitory computer-readable storage medium has stored one or more programs. The one or more programs, when executed by one or more processors, are used for performing a data searching method. The method includes:

acquiring a searching string input by a user;

acquiring an attribute type of a first character string in the searching string according to a second character string in the searching string; the searching string at least includes the first character string and the second character string;

performing a data searching according to the searching string, the first character string and the attribute type of the first character type.

Assuming that mentioned above is the first possible embodiment, then in the second embodiment provided on the basis of the first possible embodiment, the step of acquiring the attribute type of the first character string in the searching string according to the second character string in the searching string includes:

acquiring at least two character strings from the searching string;

detecting whether the at least two character strings include a preset key character string;

when the second character string in the at least two character strings is a preset key character string, taking the attribute type corresponding to the preset key character string as the attribute type of the first character string.

In the third possible embodiment provided on the basis of the first possible embodiment, the step of performing the data searching according to the searching string, the first character string and the attribute type of the first character string includes:

performing the data searching in the database respectively according to the searching string, and according to the first character string and the attribute type of the first character string, acquiring the web page links in the database that match the searching string or match the first character string and the attribute type of the first character string as the first search result.

In the fourth possible embodiment provided on the basis of the first possible embodiment, the step of performing the data searching according to the searching string, the first character string and the attribute type of the first character string includes:

performing the data searching according to the searching string to acquire a second search result that includes the web page links matching the searching string;

performing the data searching according to the first character string to acquire a third search result that includes the web page links matching the first character string;

filtering the third search result according to the attribute type of the first character string to acquire a fourth search result;

combining the second search result with the fourth search result.

In the third possible embodiment provided on the basis of any possible above-mentioned embodiment, the first character string includes attributes of the second character string.

An embodiment of the disclosure provides a system for data searching, which may implement the above methods of the disclosure.

The system for data searching may include a server, such as a search engine server.

A mapping relationship between multiple preset key character strings and attribute types is stored in the server in advance. In an embodiment, the mapping relationship may be stored in a database in the server.

When the server receives a searching string input by a user, the server acquires a first character string and a second character string from the searching string, and acquires an attribute type of the first character string according to the second character string.

Specifically, the server detects whether the second character string is a preset key character string according to the mapping relationship between multiple preset key character strings and attribute types that is stored in the database. When the second character string is found in the mapping relationship, the server determines that the second character string is a preset key character string, and further determines an attribute type of the second character string according to the mapping relationship. The server then acquires the attribute type of the second character string as an attribute type of the first character string.

After that, the server performs a data searching according to the searching string, and the first character string and the attribute type of the first character string.

Specifically, the server may perform the data searching in a database respectively according to the searching string, and according to the first character string and the attribute type of the first character string. Web page links in the database that match the searching string or match the first character string and the attribute type of the first character string are acquired as a search result.

Alternatively, the server may perform a data searching according to the searching string to acquire a second search result that comprises web page links match the searching string, and perform a data searching according to the first character string to acquire a third search result that comprises web page links match the first character string. The server may further filter the third search result according to the attribute type of the first character string to acquire a fourth search result, and combine the second search result with the fourth search result to obtain a final search result.

In an embodiment, the first character string may include attributes of the second character string.

In another embodiment of the disclosure, the system for data searching may further include a terminal. When a user needs to perform a data searching, the user inputs a searching string to be searched for into a search bar provided by the terminal.

Those skilled in the art should understand that all or part of the steps in the above-mentioned embodiments can be accomplished by hardware, or by instructing the relevant hardware through programs. The programs can be stored on a computer-readable storage medium. The computer-readable storage medium may be a read-only memory, a disk, an optical disk, etc.

The above are only the preferable embodiments of the disclosure, and are not intended to limit the disclosure. All the modifications, equivalents, improvement and others within the spirit and principle of the disclosure are included in the scope of the disclosure.

1. (canceled)

2. (canceled)

3. (canceled)

4. (canceled)

5. (canceled)

6. A device for data searching, comprising:
a searching string acquiring module, stored in a memory and executed by a processor, and configured to acquire a searching string input by a user;
an attribute type acquiring module, stored in a memory and executed by a processor, and configured to acquire an attribute type of a first character string in the searching string according to a second character string in the searching string, wherein the searching string at least comprises the first character string and the second character string; and
a data searching module, stored in a memory and executed by a processor, and configured to perform a data searching according to the searching string, the first character string and the attribute type of the first character string.

7. The device according to claim 6, wherein the attribute type acquiring module comprises:
a segmenting unit configured to acquire at least two character strings from the searching string;
a preset detecting unit configured to detect whether the at least two character strings include a preset key character string;
an attribute type acquiring unit configured to: when a second character string in the at least two character strings is a preset key character string, acquire an attribute type corresponding to the preset key character string as the attribute type of the first character string.

8. The device according to claim 6, wherein data searching module comprises:
a first searching unit configured to perform the data searching in a database respectively according to the searching string, and according to the first character string and the attribute type of the first character string, and to acquire web page links in the database that match the searching string or match the first character string and the attribute type of the first character string as a first search result.

9. The device according to claim 6, wherein data searching module further comprises:
a second searching unit configured to perform a data searching according to the searching string to acquire a second search result that comprises web page links matching the searching string;
a third searching unit configured for perform a data searching according to the first character string to acquire a third search result that comprises web page links matching the first character string;
a filtering unit configured to filter the third search result according to the attribute type of the first character string to acquire a fourth search result; and
a combining unit configured to combine the second search result with the fourth search result.

10. The device according to claim 6, wherein the first character string comprises attributes of the second character string.

11. A method for data searching, comprising:
acquiring a first character string and a second character string from a searching string;
acquiring an attribute type of the first character string according to the second character string; and
performing a data searching according to the searching string, and the first character string and the attribute type of the first character string.

12. The method according to claim 11, further comprising:
establishing a mapping relationship between multiple preset key character strings and attribute types;
wherein the step of acquiring the attribute type of the first character string comprises:
detecting whether the second character string is a preset key character string;
determining an attribute type of the second character string according to the mapping relationship, when the second character string is a preset key character string; and
acquiring the attribute type of the second character string as an attribute type of the first character string.

13. The method according to claim 12, wherein the step of performing the data searching comprises:
performing the data searching in a database respectively according to the searching string, and according to the first character string and the attribute type of the first character string; and
acquiring web page links in the database that match the searching string or match the first character string and the attribute type of the first character string as a search result.

14. The method according to claim 12, wherein the step of performing the data searching comprises:
performing a data searching according to the searching string to acquire a second search result that comprises web page links matching the searching string;
performing a data searching according to the first character string to acquire a third search result that comprises web page links matching the first character string;
filtering the third search result according to the attribute type of the first character string to acquire a fourth search result; and
combining the second search result with the fourth search result to obtain a final search result.

15. The method according to claim 11, wherein the first character string includes attributes of the second character string.

16. A system for data searching, comprising a server configured to:
acquire a first character string and a second character string from a searching string;
acquire an attribute type of the first character string according to the second character string; and
perform a data searching according to the searching string, and the first character string and the attribute type of the first character string.

17. The system according to claim 16, wherein a mapping relationship between multiple preset key character strings and attribute types is stored in the server;
the server is further configured to:
detect whether the second character string is a preset key character string stored in the server;
determine an attribute type of the second character string according to the mapping relationship, when the second character string is a preset key character string; and
acquire the attribute type of the second character string as an attribute type of the first character string.

18. The system according to claim 17, wherein the server is further configured to:
perform the data searching in a database respectively according to the searching string, and according to the first character string and the attribute type of the first character string; and
acquire web page links in the database that match the searching string or match the first character string and the attribute type of the first character string as a search result.

19. The system according to claim 17, wherein the server is further configured to:
perform a data searching according to the searching string to acquire a second search result that comprises web page links matching the searching string;
perform a data searching according to the first character string to acquire a third search result that comprises web page links matching the first character string;
filter the third search result according to the attribute type of the first character string to acquire a fourth search result; and
combine the second search result with the fourth search result to obtain a final search result.

20. The system according to claim 16, wherein the first character string includes attributes of the second character string.

21. (canceled)

22. A non-transitory computer-readable storage medium including a set of instructions that, when executed, cause at least one processor to perform steps comprising:
acquiring a first character string and a second character string from a searching string;
acquiring an attribute type of the first character string according to the second character string; and
performing a data searching according to the searching string, and the first character string and the attribute type of the first character string.

23. The non-transitory computer-readable storage medium according to claim 22, further comprising instructions, when executed, cause the at least one processor to establish a mapping relationship between multiple preset key character strings and attribute types;
wherein the step of acquiring the attribute type of the first character string comprises:
detecting whether the second character string is a preset key character string;
determining an attribute type of the second character string according to the mapping relationship, when the second character string is a preset key character string; and
acquiring the attribute type of the second character string as an attribute type of the first character string.

24. The non-transitory computer-readable storage medium according to claim 23, wherein the step of performing the data searching comprises:
performing the data searching in a database respectively according to the searching string, and according to the first character string and the attribute type of the first character string; and
acquiring web page links in the database that match the searching string or match the first character string and the attribute type of the first character string as a search result.

25. The non-transitory computer-readable storage medium according to claim 23, wherein the step of performing the data searching comprises:
performing a data searching according to the searching string to acquire a second search result that comprises web page links matching the searching string;
performing a data searching according to the first character string to acquire a third search result that comprises web page links matching the first character string;
filtering the third search result according to the attribute type of the first character string to acquire a fourth search result; and
combining the second search result with the fourth search result to obtain a final search result.

26. The non-transitory computer-readable storage medium according to claim 22, wherein the first character string includes attributes of the second character string.
